(19) United States
(12) Patent Application Publication
(10) Pub. No.: US 2009/0192274 A1
(43) Pub. Date: Jul. 30, 2009

(54) THERMOPLASTIC POLYURETHANES AND THEIR USE

(75) Inventors: Henricus Peerlings, Solingen (DE); Juergen Winkler, Langenfeld (DE); Faisal Shafiq, Kaarst (DE); Markus Broich, Huckelhoven (DE)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/358,360

(22) Filed: Jan. 23, 2009

(30) Foreign Application Priority Data
Jan. 25, 2008 (DE) 102008006004.6

(51) Int. Cl. C08L 75/04

(52) U.S. Cl. 525/453

(57) ABSTRACT

Thermoplastic polyurethanes and molding compositions containing the same having improved surface resistance (writing and scratch resistance) and good industrial processability, and the use thereof, such polyurethanes prepared by reacting: (a) one or more organic diisocyanates; (b) a chain extender comprising at least one low molecular weight polyol having on average at least 1.8 and not more than 3.0 Zerewitinoff-active hydrogen atoms and a number-average molecular weight Mₙ of 60 to 400 g/mol; and (c) at least one polyol component having a number-average molecular weight Mₙ of 450 to 10,000 g/mol and on average from at least 1.8 to not more than 3.0 Zerewitinoff-active hydrogen atoms; wherein the ratio of the number of isocyanate groups in component (a) to the number of isocyanate-reactive groups in components (b) and (c) is 0.9:1 to 1.1:1; in the presence of (d) a mixture of polyorganosiloxanes of the general formula (R₂SiO)ₙ, in an amount of 0.4 to 10 wt. % based on the thermoplastic polyurethane, wherein each R independently represents an organic hydrocarbon radical having 1 to 27 carbon atoms which can be linear and/or branched, and n represents an integer of 3 to 6000, wherein the mixture consists of (d1) 0.2 to 2 wt. %, based on the thermoplastic polyurethane, of one or more polyorganosiloxanes (R₂SiO)ₙ wherein n=3 to 300 and (d2) 0.2 to 8 wt. %, based on the thermoplastic polyurethane, of one or more polyorganosiloxanes (R₂SiO)ₙ wherein n=1000 to 6000.

### BACKGROUND OF THE INVENTION

Thermoplastic polytrethanes (TPUs) are very important industrially because of their good elastomeric properties and thermoplastic processability. An overview of the preparation, properties and applications of TPUs is given, for example, in Kunststoff Handbuch [G. Becker, D. Braun], Volume 7 “Polyurethane”, Munich, Vienna, Carl Hanser Verlag, 1983.

TPUs are mostly composed of linear polyols (macrodiols), such as polyester, polyether or polycarbonate diols, organic diisocyanlates and short-chained, mostly difunctional alcohols (chain extenders). They can be prepared continuously or discontinuously. The most well known preparation processes are the belt process (e.g., British Patent Pub. No. GB 1057018) and the extruder process (e.g., German Patent Pub. No. DE1964834), the entire contents of each of which is hereby incorporated herein by reference.

The synthesis of the thermoplastically processable polyurethane elastomers can be carried out either stepwise (prepolymer metering process) or by simultaneously reacting all the components in one stage (one-shot metering process).

DE-A 102 30 020 describes the use of polyorganosiloxanes for improving the rub and scratch resistance (mechanical surface resistance) of TPUs. However, when TPUs containing these additives are processed, surface defects occur after some time (after several shots) in the injection-molding process, and these defects result in undesirably high reject rates.

### BRIEF SUMMARY OF THE INVENTION

The present invention relates, in general, to thermoplastic polyurethane molding compositions having improved surface resistance (writing and scratch resistance) and good industrial processability, and to the use thereof.

Thermoplastic polyurethanes (TPUs) according to the various embodiments of the present invention exhibit improved mechanical surface resistance and at the same time good industrial processability and do not exhibit surface defects when processed.

The present invention therefore provides thermoplastic polyurethanes which are obtainable from
a) one or more organic diisocyanates,
b) at least one low molecular weight polyol having on average at least 1.8 and not more than 3.0 Zerewitinoff-active hydrogen atoms and a number-average molecular weight Mₙ of from 60 to 400 g/mol as chain extender and
c) at least one polyol component having a number-average molecular weight Mₙ of from 450 to 10,000 g/mol and on average from at least 1.8 to not more than 3.0 Zerewitinoff-active hydrogen atoms,
   wherein the ratio of the number of isocyanate groups in component a) to the number of isocyanate-reactive groups in components b), c) and optionally g) is from 0.9:1 to 1.1:1,
   in the presence of
d) from 0.4 to 10 wt. %, based on thermoplastic polyurethane, of a mixture of polyorganosiloxanes of the general formula (R₂SiO)ₙ, wherein R represents an organic hydrocarbon radical which can be both linear and branched in structure and contains from 1 to 27 carbon atoms, and n can be an integer from 3 to 6000, wherein the mixture consists of
   d1) from 0.2 to 2 wt. %, based on thermoplastic polyurethane, of one or more polyorganosiloxanes (R₂SiO)ₙ wherein n=from 3 to 300 and
   d2) from 0.2 to 8 wt. %, based on thermoplastic polyurethane, of one or more polyorganosiloxanes (R₂SiO)ₙ wherein n=from 1000 to 6000,
   with the addition of
e) optionally catalysts,
f) optionally additives and/or auxiliary substances,
g) optionally chain terminators.

One embodiment of the present invention includes thermoplastic polyurethane prepared by a process comprising reacting:

(a) one or more organic diisocyanates;

(b) a chain extender comprising at least one low molecular weight polyol having on average at least 1.8 and not more than 3.0 Zerewitinoff-active hydrogen atoms and a number-average molecular weight Mₙ of 60 to 400 g/mol; and

(c) at least one polyol component having a number-average molecular weight Mₙ of 450 to 10,000 g/mol and on average from at least 1.8 to not more than 3.0 Zerewitinoff-active hydrogen atoms; wherein the ratio of the number of isocyanate groups in component (a) to the number of isocyanate-reactive groups in components (b) and (c) is 0.9:1 to 1.1:1,

in the presence of (d) a mixture of polyorganosiloxanes of the general formula (R₂SiO)ₙ, in an amount of 0.4 to 10 wt. % based on the thermoplastic polyurethane, wherein each R independently represents an organic hydrocarbon radical having 1 to 27 carbon atoms which can be linear and/or branched, and n represents an integer of 3 to 6000, wherein the mixture consists of
(d1) 0.2 to 2 wt. %, based on the thermoplastic polyurethane, of one or more polyorganosiloxanes (R₂SiO)ₙ, wherein n=3 to 300 and
(d2) 0.2 to 8 wt. %, based on the thermoplastic polyurethane, of one or more polyorganosiloxanes (R₂SiO)ₙ wherein n=1000 to 6000.

Another embodiment of the present invention includes molded articles and interior fittings for motor vehicles comprising a polyurethane according to the invention.

Other embodiments of the present invention include processes for preparing a molded article, the processes comprising: (i) providing a polyurethane according to claim 1; and (ii) subjecting the polyurethane to injection molding, extrusion and/or a powder slush process.

### DETAILED DESCRIPTION OF THE INVENTION

As used herein, the singular terms “a” and “the” are synonymous and used interchangeably with “one or more” and “at least one,” unless the language and/or context clearly indicates otherwise. Accordingly, for example, reference to “a chain extender” herein or in the appended claims can refer to a single chain extender or more than one chain extender. Additionally, all numerical values, unless otherwise specifically noted, are understood to be modified by the word “about.”

As organic diisocyanates (a) there can be used aliphatic, cycloaliphatic, araliphatic, aromatic and heterocyclic diisocyanates or any desired mixtures of such diisocyanates (see HOUBEN-WEYL “Methoden der organischen Chemie”, Volume E20 “Makromolekulare Stoffe” , Georg Thieme Verlag, Stuttgart, New York 1987, p. 1587-1593 or Justus Liebigs Annalen der Chemie, 562, pages 75 to 136). Specific examples which may be mentioned include: aliphatic diisocyanates, such as ethylene diisocyanate, 1,4-tetramethylene diisocyanate, 1,6-hexamethylene diisocyanate, 1,12-dodecane diisocyanate; cycloaliphatic diisocyanates, such as isophorone diisocyanate, 1,4-cyclohexane diisocyanate, 1-methyl-2,4-cyclohexane diisocyanate and 1-methyl-2,6-cyclohexane diisocyanate and also the corresponding isomer mixtures, 4,4′-dicyclohexylmethane diisocyanate, 2,4′-dicyclohexylmethane diisocyanate and 2,2′-di-cyclohexylmethane diisocyanate and also the corresponding isomer mixtures; in addition, aromatic diisocyanates, such as 2,4-toluylene diisocyanate, mixtures of 2,4-toluylene diisocyanate and 2,6-toluylene diisocyanate, 4,4′-diphenylmethane diisocyanate, 2,4′-diphenylmethane diisocyanate and 2,2′-diphenylmethane diisocyanate, mixtures of 2,4′-diphenylmethane diisocyanate and 4,4′-diphenylmethane diisocyanate, urethane-modified or carbodiimide-modified liquid 4,4′-diphenylmethane diisocyanates or 2,4′-diphenyl-methane diisocyanates, 4,4′-diisocyanato-1,2-diphenylethane and 1,5-naphthylene diisocyanate. Preference is given to the use of 1.,6-hexamethylene diisocyanate, 1,4-cyclohexane diisocyanate, isophorone diisocyanate, dicyclohexylmethane diisocyanate, diphenylmethane diisocyanate isomer mixtures having a 4,4′-diphenylmethane diisocyanate content of more than 96 wt. %, and in particular 4,4′-diphenylmethane diisocyanate and 1,5-naphthylene diisocyanate. The mentioned diisocyanates can be used individually or in the form of mixtures with one another. They can also be used together with up to 15 mol % (calculated on total diisocyanate) of a polyisocyanate, but the maximum amount of polyisocyanate added must be such that the resulting product is still thermoplastically processable. Examples of polyisocyanates include triphenylmethane-4,4′,4″-triisocyanate and polyphenyl-polymethylene polyisocyanate.

The chain extenders b) possess on average preferably from 1.8 to 3.0 Zerewitinoff-active hydrogen atoms and have a molecular weight of from. 60 to 400. They are preferably to be understood as being those having from two to three, particularly preferably two, hydroxyl groups.

As chain extenders b) there are preferably used one or more compounds from the group of the aliphatic diols having from 2 to 14 carbon atoms, such as, for example, ethanediol, 1,2-propanediol, 1,3-propanediol, 1,4-butanediol, 2,3-butanediol, 1,5-pentanediol, 1,6-hexanediol, diethylene glycol, dipropylene glycol, 1,4-cyclohexanediol, 1,4-dimethanolcyclohexane and neopentyl glycol. Also suitable, however, are diesters of terephthalic acid with glycols having from 2 to 4 carbon atoms, for example terephthalic acid bis-ethylene glycol or terephthalic acid bis-1,4-butanediol, hydroxyalkylene ethers of hydroquinone, for example 1,4-di(β-hydroxyethyl)-hydroquinone, ethoxylated bisphenols, for example 1,4-di(β-hydroxyethyl)-bisphenol A. There are particularly preferably used as chain extenders ethanediol, 1,4-butanediol, 1,6-hexanediol, 1,4-dimethanolcyclohexane, 1,4-di((-hydroxyethyl)-hydroquinone or 1,4-di(β-hydroxyethyl)-bisphenol A. It is additionally possible to add smaller amounts of triols.

As the polyol component c) there are used those having on average from at least 1.8 to not more than 3.0 Zerewitinoff-active hydrogen atoms and a number-average molecular weight M̅ₙ of from 450 to 10,000. The polyols often contain small amounts of non-linear compounds resulting from their preparation. The term “substantially linear polyols” is therefore often also used. Polyester, polyether, polycarbonate diols or mixtures thereof are preferred.

Particular preference is given to compounds containing from two to three, preferably two, hydroxyl groups, especially those having number-average molecular weights M̅ₙ of from 450 to 6000, particularly preferably those having number-average molecular weights M̅ₙ of from 600 to 4500; hydroxyl-group-containing polyesters, polyethers and polycarbonates are particularly preferred.

Suitable polyether diols can be prepared by reacting one or more alkylene oxides having from 2 to 4 carbon atoms in the alkylene radical with a starter molecule containing two active hydrogen atoms bonded therein. Examples of alkylene oxides which may be mentioned include: ethylene oxide, 1,2-propylene oxide, epichlorohydrin and 1,2-butylene oxide and 2,3-butylene oxide. Ethylene oxide, propylene oxide and mixtures of 1,2-propylene oxide and ethylene oxide are preferably used. The alkylene oxides can be used individually, alternately in succession or in the form of mixtures. There come into consideration as starter molecules, for example: water, amino alcohols, such as N-alkyl-diethanolamines, for example N-methyl-diethanolamine, and diols, such as ethylene glycol, 1,3-propylene glycol, 1,4-butanediol and 1,6-hexanediol. It is optionally also possible to use mixtures of starter molecules. Suitable polyether polyols are also the hydroxyl-group-containing polymerisation products of tetrahydrofuran. It is also possible to use trifunctional polyethers in amounts of from 0 to 30 wt. %, based on the difunctional polyethers, but in a maximum amount such that the resulting product is still thermoplastically deformable. The substantially linear polyether diols preferably have number-average molecular weights M̅ₙ of from 450 to 6000. They can be used either individually or in the form of mixtures with one another.

Suitable polyester diols can be prepared, for example, from dicarboxylic acids having from 2 to 12 carbon atoms, preferably from 4 to 6 carbon atoms, and polyhydric alcohols. There come into consideration as dicarboxylic acids, for example: aliphatic dicarboxylic acids, such as succinic acid, glutaric acid, adipic acid, suberic acid, azelaic acid and sebacic acid, or aromatic dicarboxylic acids, such as phthalic acid, isophthalic acid and terephthalic acid. The dicarboxylic acids can be used individually or in the form of mixtures, for example in the form of a succinic, glutalic and adipic acid mixture. It can optionally be advantageous for the preparation of the polyester diols to use instead of the dicarboxylic acids the corresponding dicarboxylic acid derivatives, such as carboxylic acid diesters having from 1 to 4 carbon atoms in the alcohol radical, carboxylic acid anhydrides or carboxylic acid chlorides. Examples of polyhydric alcohols are glycols having from 2 to 10, preferably from 2 to 6, carbon atoms, for example ethylene glycol, diethylene glycol, 1,4-butanediol, 1,5-pentanediol, 1,6-hexanediol, 1,10-decanediol, 2,2-dimethyl-1,3-propanediol, 1,3-propanediol or dipropylene glycol. Depending on the desired properties, the polyhydric alcohols can be used on their own or in the form of a mixture with one another. Also suitable are esters of carbonic acid with the mentioned diols, in particular those having from 4 to 6 carbon atoms, such as 1,4-butanediol or 1,6-hexanediol, condensation products of ω-hydroxycarboxylic acids, such as ω-hydroxycaproic acid, or polymerisation products of lactones, for example optionally substituted ω-caprolactones. There are preferably used as polyester diols ethanediol polyadipates, 1,4-butanediol polyadipates, ethanediol-1,4butanediol polyadipates, 1,6-hexanediol-neopentyl glycol polyadipates, 1,6-hexanediol-1,4-butanediol polyadipates and polycaprolactones. The polyester diols have number-average molecular weights M̅ₙ of from 450 to 10,000 and can be used individually or in the form of mixtures with one another.

As polydiorganosiloxanes d) there are used compounds of the general formula (R₂SiO)ₙ, wherein R represents an organic hydrocarbon radical which can be both linear and branched in structure and contains from 1 to 27 carbon atoms. Of the repeating units, at least 3 and not more than 6000 are present. The polyorganosiloxanes d1) and d2) can be added without a solvent or in the form of a masterbatch in a carrier substance. Suitable as carrier substance are thermoplastic elastomers, such as, for example, polyether esters, polyester esters, TPUs, styrene-ethylene-butadiene-styrene (SEBS), acrylonitrile-butadiene-styrene (ABS), styrene-acrylonitrile (SAN), polyamide (PA), acrylate-styrene-acrylate block copolymer (ASA), polybutylene terephthalate (PBT), polycarbonate (PC), polyether block amide (PEBA), polymethyl methacrylate (PMMA), polyoxymethylene (POM) or polyvinyl chloride (PVC).

The polyorganosiloxane can be added to the TPU raw materials during preparation of the TPU or it can be added subsequently to the finished TPU, for example by means of compounding.

The relative amounts of the Zerewitinoff-active compounds are preferably so chosen that the ratio of the number of isocyanate groups to the number of isocyanate-reactive groups is from 0.9:1 to 1.1:1.

Suitable catalysts e) are the conventional tertiary amines known according to the prior art, such as, for example, triethylamine, dimethylcyclohexylamine, N-methylmorpholine, N,N′-dimethylpiperazine, 2-(dimethylamino-ethoxy)ethanol, diazabicyclo[2.2.2]octane and the like, as well as in particular organic metal compounds, such as titanic acid esters, iron compounds, bismuth compounds or tin compounds, such as tin diacetate, tin dioctoate, tin dilaurate or the tindialkyl salts of aliphatic carboxylic acids, such as dibutyltin diacetate or dibutyltin dilaurate or the like. Preferred catalysts are organic metal compounds, in particular titanic acid esters, iron, tin, zirconium and bismuth compounds. In general, the total amount of catalysts in the TPUs according to the invention is preferably from 0 to 5 wt. %, more preferably from 0 to 2 wt. %, based on the total amount of TPU.

The thermoplastic polyurethanes according to the invention can contain auxiliary substances and additives f). Typical auxiliary substances and additives are lubricants and mold release agents, such as fatty acid esters, metal soaps thereof, fatty acid amides, fatty acid ester amides, antiblocking agents, flameproofing agents, plasticizers (as described, for example, in M. Szycher in M. Szycher's Handbook of Polyurethanes, 1999, CRC Press, page 8-28 to 8-30. Examples which may be mentioned include phosphates, carboxylates (such as e.g. phthalates, adipates, sebacates), silicones and alkyl sulfonic acid esters), inhibitors, stabilisers against hydrolysis, heat and discolouration, light stabilisers (preferably UV stabilisers, antioxidants and/or HALS compounds. Further details can be found in the specialist literature and are described, for example, in Plastics Additives Handbook, 2001 5th Ed., Carl Hanser Verlag, Munich), colourings, pigments, inorganic and/or organic fillers, substances having fungistatic and bacteriostatic action, and mixtures thereof.

Further details regarding the mentioned auxiliary substances and additives can be found in the specialist literature, for example the monograph of J. H. Saunders and K. C. Frisch “High Polymers”, Volume XVI, Polyurethane, Part 1 and 2, Verlag Interscience Publishers 1962 and 1964, Taschenbuch fur Kunststoff-Additive by R. Gächter and H. Müller (Hanser Verlag Munich 1990) or DE-A 29 01 774.

Further additives which can be incorporated into the TPU are thermoplastics, for example polycarbonates and acrylonitrile/butadiene/styrene terpolymers (AES), in particular ABS. It is also possible to use other elastomers, such as rubber, ethylene/vinyl acetate copolymers, styrene/butadiene copolymers and other TPUs.

The addition of the auxiliary substances and additives f) can take place during the TPU preparation process and/or during additional compounding of the TPU.

Monofunctional compounds that are reactive towards isocyanates can be used as so-called chain terminators g) in amounts of up to 2 wt. %, based on TPU. There are suitable, for example, monoamines, such as butyl- and dibutyl-amine, octylamine, stearylamine, N-methylstearylamine, pyrrolidine, piperidine or cyclohexylamine, monoalcohols, such as butanol, 2-ethylhexanol, octanol, dodecanol, stearyl alcohol, the various amyl alcohols, cyclohexanol and ethylene glycol monomethyl ether.

The TPUs according to the invention are preferably used in the injection-molding process, the extrusion process and/or the powder slush process.

The TPUs according to the invention are preferably used in the production of heat-resistant moldings and skins having good mechanical surface resistance.

The TPUs are preferably used for the interior fitting of motor vehicles.

The invention will now be described in further detail with reference to the following non-limiting examples.

### EXAMPLES

Abbreviations used hereinbelow:
PE 225B Polyester diol having a molecular weight of Mₙ=2250 g/mol; product of Bayer MaterialScience AG
Acclaim® 2220 N Polyether diol (mixed ether of C₃— and C₂-alkylene units) having a molecular weight of Mₙ=2250 g/mol; product of Bayer MaterialScience AG
HDI 1,6-Hexamethylene diisocyanate
MDI 4,4′-Diphenylmethane diisocyanate
HDO 1,6-Hexanediol
BDO 1,4-Butanediol
Irganox® 1010Antioxidant from Ciba Specialty Chemicals GmbH
Tinuvin® 234 Light stabiliser based on a benzotriazole from Ciba Specialty Chemicals GmbH
EBS Ethylene-bis-stearylamide
DBTL Dibutyltin dilaurate
SO Tin dioctoate
MB50-017 Siloxane masterbatch from Dow Coming consisting of 50% polysiloxane (n˜3000) and 50% of an aromatic TPU
MB35-027 Siloxane masterbatch from Dow Coming consisting of 35% polysiloxane (n˜3000) and 50% of an aliphatic TPU
M350 Polyorganosiloxane with n˜100-1507 silicone oil from GE Silicones

### Preparation of an Aromatic TPU (TPU-1):

A mixture of 643 g of PE1225B, 71 g of EDO, 2 g of Irganox® 1010, 5 g of Tinuvin®, 234.2 g of EBS and 50 ppm of SO (based on the amount of polyol) was heated to 160° C. while stirring with a blade agitator at a speed of 500 revolutions per minute (rpm). 273 g of MDI were then added. Stirring was subsequently carried out until the maximum possible increase in viscosity had been obtained, and the TPU was then poured out. The material was subjected to thermal after-treatment for 30 minutes at 80° C. and was subsequently granulated. This material was used as the base material for Examples 1 to 3.

Preparation of an aliphatic TPU (TPU-2):

A mixture of 500 g of PE 225B, 214 g of Acclaim® 2220N, 91 g of HDO, 5 g of Irganox® 1010, 5 g of Tinuvin 234 and 50 ppm of DBTL (based on the amount of polyol) was heated to 130° C. while stirring with a blade agitator at a speed of 500 revolutions per minute (rpm). 183 g of HDI were then added. Stirring was subsequently carried out until the maximum possible increase in viscosity had been obtained, and the TPU was then poured out. The material was subjected to thermal after-treatment for 30 minutes at 80° C. and was subsequently granulated. This material was used as the base material for Examples 4 to 9.

Masterbatches or silicone oil (the exact formulations are to be found in Table 1) and carbon black (2 wt. %, based on TPU, Elfiex® 435 from Cabot) were added to the TPU granules prepared according to the general descriptions. The mixtures were extruded on an extruder of typo DSE 25, 4 Z, 360 Nm having the following structure:
1. cold intake zone with conveyor elements,
2. first heating zone (165° C.) with first kneading zone,
3. second heating zone (175° C.) with conveyor elements and second kneading zone,
4. third heating zone (180° C.) with kneading zone, conveyor elements and vacuum degassing,
5. deflection head (185° C.) and die (180° C.),
   with a delivery rate of 10 kg/h and at a speed of 220 rpm; the extrudates were then processed to granules by means of an extrudate granulator and to injection-molded sheets by means of an injection-molding machine.

### Determination of Industrial Processability:

During the injection molding attention was paid to the industrial processability. The intake behaviour in the hopper of the injection-molding machine was evaluated, for example. It was checked whether defects and/or a coating were visible on the molding. It was also assessed how quickly a molding coating was formed and how thick this was. The following rating was introduced for the purposes of the assessment:
Rating 1: no coating visible;
Rating 2; not much coating visible, also does not become thicker;
Rating 3: not much coating visible but becomes thicker and thicker after further shots;
Rating 4: a lot of coating quickly forms and rapidly becomes thicker on further shots;
Only a rating of 1 or 2 is acceptable.

1. Determination of Surface Sensitivity

Two tests were carried out to determine the surface sensitivity:

Crockmeter test: These test were carried out on an injection-molded body with a grained surface, under the following conditions: rubbing pressure: 10N, rubbing path: 260 mm, time per nib: 15 seconds, number of strokes: 100.

Implementation. The abrasive cotton fabric was stretched out beneath the bearing surface and the test was carried out under the conditions described above. The damage to the surface was assessed qualitatively. The rating “poor” means that there is clearly visible abrasion of the surface. The rating “good” means that there is no abrasion or the abrasion is barely visible.

Scratch test: This test was carried out on a grained surface using an Erichsen rod with one stroke and a force of 10 N. The damage to the surface was assessed qualitatively. The rating “poor” means that there is clearly visible damage to the surface. The rating “good” means that there is no visible surface damage or the surface damage is barely visible.

The results of the tests are to be found in the table.

TABLE
Results

| | | Batch; Amount | Amount | | | |
|---|---|---|---|---|---|---|
| | Type of example, | of siloxane [%] | of M350 | Industrial | Crockmeter | Scratch |
| Ex. | TPU | in TPU-1 or -2 | [%] | processability | test | test |
| 1 | comparison, TPU-1 | none | none | rating 1 | poor | poor |
| 2 | comparison, TPU-1 | MB50-017; 2.5 | none | rating 2 | good | poor |
| 3 | according to the | MB50-017; 2 | 0.5 | rating 2 | good | good |
| | invention, TPU-1 | | | | | |
| 4 | comparison, TPU-2 | none | none | rating 1 | poor | poor |
| 5 | comparison, TPU-2 | MB35-027; 2.5 | none | rating 4 | good | good |
| 6 | according to the | MB35-027; 2 | 0.5 | rating 2 | good | good |
| | invention, TPU-2 | | | | | |
| 7 | according to the | MB35-027; 1.5 | 1 | rating 2 | good | good |
| | invention, TPU-2 | | | | | |
| 8 | according to the | MB35-027; 0.5 | 2 | rating 1 | good | good |
| | invention, TPU-2 | | | | | |
| 9* | comparison, TPU-2 | none | 2.5 | rating 1 | good | poor |

*In this test, intake problems in the hopper occurred, as a result of which delamination occurred.

In Examples 1 to 3, an aromatic TPU (TPU-1) was used. Without polyorganosiloxane (Example 1), the surface resistance is poor. When high molecular weight polyorganosiloxane was used (Example 2), the result from the crockmeter test was good but the scratch test was not passed. The TPU from Example 3 fulfilled all the requirements made in respect of surface sensitivity and achieved good industrial processability.

In Examples 4 to 9, an aliphatic TPU (TPU-2) was used. In Comparison Examples 4, 5 and 9, no polyorganosiloxane (Example 4), only a high molecular weight polyorganosiloxane (Example 5) or only a low molecular weight polyorganosiloxane (Example 9) was used. The TPUs from Examples 4 and 9 exhibited a poor result in the scratch test. In addition, there were intake problems in Example 9 in the hopper of the injection-molding machine. The material from Example 5 had good surface resistance but exhibited problems in industrial processability.

The TPUs from Examples 6 to 8 according to the invention fulfilled all the requirements made in respect of surface sensitivity and exhibited good industrial processability.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A thermoplastic polyurethane prepared by a process comprising reacting:
(a) one or more organic diisocyanates;
(b) a chain extender comprising at least one low molecular weight polyol having on average at least 1.8 and not more than 3.0 Zerewitinoff-active hydrogen atoms and a number-average molecular weight Mₙ of 60 to 400 g/mol; and
(c) at least one polyol component having a number-average molecular weight Mₙ of 450 to 10,000 g/mol and on average from at least 1.8 to not more than 3.0 Zerewitinoff-active hydrogen atoms; wherein the ratio of the number of isocyanate groups in component (a) to the number of isocyanate-reactive groups in components (b) and (c) is 0.9:1 to 1.1:1,
in the presence of (d) a mixture of polyorganosiloxanes of the general formula (R₂SiO)ₙ, in an amount of 0.4 to 10 wt. % based on the thermoplastic polyurethane, wherein each R independently represents an organic hydrocarbon radical having 1 to 27 carbon atoms which can be linear and/or branched, and n represents an integer of 3 to 6000, wherein the mixture consists of
(d1) 0.2 to 2 wt. %, based on the thermoplastic polyurethane, of one or more polyorganosiloxanes (R₂SiO)ₙ wherein n=3 to 300 and
(d2) 0.2 to 8 wt. %, based on the thermoplastic polyurethane, of one or more polyorganosiloxanes (R₂SiO)ₙ wherein n=1000 to 6000.

2. The thermoplastic polyurethane according to claim 1, wherein the process comprises: reacting (a), (b) and (c) in the presence of the mixture and one or more additional components selected from the group consisting of (e) catalysts; (f) additives and auxiliary substances; and (g) chain terminators.

3. The thermoplastic polyurethane according to claim 1, wherein the at least one polyol component has a number average molecular weight of 450 to 6000 g/mol.

4. The thermoplastic polyurethane according to claim 1, wherein the at least one polyol component has a number average molecular weight of 600 to 4500 g/mol.

5. A molded article comprising a thermoplastic polyurethane according to claim 1.

6. A process for preparing molded article, the process comprising: (i) providing a thermoplastic polyurethane according to claim 1; and (ii) subjecting the polyurethane to injection molding.

7. A process for preparing molded article, the process comprising: (i) providing a thermoplastic polyurethane according to claim 1; and (ii) subjecting the polyurethane to extrusion.

8. A process for preparing molded article, the process comprising: (i) providing a thermoplastic polyurethane according to claim 1; and (ii) subjecting the polyurethane to a powder slush process.

9. An interior fitting of a motor vehicle comprising a thermoplastic polyurethane according to claim 1.
